(19) United States
(12) Patent Application Publication
(10) Pub. No.: US 2026/0105542 A1
(43) Pub. Date: Apr. 16, 2026

(54) VEHICLE AND SERVICE PLATFORM FOR ELECTRIC POWER TRADING

(71) Applicants: HYUNDAI MOTOR COMPANY, Seoul (KR); KIA CORPORATION, Seoul (KR)

(72) Inventors: Jong Won Kim, Hwaseong-si (KR); Jung Hyun Noh, Hwaseong-si (KR)

(73) Assignees: HYUNDAI MOTOR COMPANY, Seoul (KR); KIA CORPORATION, Seoul (KR)

(21) Appl. No.: 19/201,884

(22) Filed: May 7, 2025

(30) Foreign Application Priority Data
Oct. 11, 2024 (KR) 10-2024-0138632

(51) Int. Cl. G06Q 50/06; B60L 58/12; G06Q 40/04; G07C 5/08; H01M 10/42; H01M 10/46

(52) U.S. Cl. CPC G06Q 50/06; G06Q 40/04; G07C 5/08; H01M 10/425; H01M 10/46; B60L 58/12; H01M 2010/4271; H01M 2220/20

(57) ABSTRACT

A vehicle for electric power trading is provided. The vehicle includes one or more processors, and a storage medium configured to store a computer-readable instruction. When the computer-readable instruction is accessed and executed by the one or more processors, the one or more processors are configured to transmit service registration information for electric power trading, and to transmit an electric power trading request. The electric power trading request includes electric power to sell, among eco-friendly electric power and general electric power, and a power capacity to sell, when a service registration confirmation is received in response to transmission of the service vehicle registration information. Electric power corresponding to the power capacity to sell is withdrawn from the vehicle according to the electric power trading request.

### CROSS-REFERENCE TO RELATED APPLICATION(S)

This application claims the benefit of priority to Korean Patent Application No. 10-2024-0138632 filed on Oct. 11, 2024, in the Korean Intellectual Property Office, the disclosure of which is incorporated herein by reference in its entirety.

### TECHNICAL FIELD

The present disclosure relates to a vehicle and a service platform for electric power trading.

### BACKGROUND

Recently, as environmental regulations in various countries have been strengthened, the RE100 campaign is underway. The RE100 campaign is a campaign to replace 100% of electric power, used by companies, with eco-friendly electric power. Here, the eco-friendly electric power may refer to electric power, generated by renewable energy sources such as solar power, wind power, and the like.

However, RE100 is still based on voluntary commitments, rather than legal obligations. As such, it may be useful to induce voluntary participation from the trading parties. To this end, it may be useful to trade eco-friendly electric power and general electric power separately.

### SUMMARY

An aspect of the present disclosure provides a vehicle and a service platform for electric power trading, capable of inducing voluntary participation in the RE100 campaign.

According to an aspect of the present disclosure, there is provided a vehicle for electric power trading. The vehicle may include one or more processors, and a storage medium configured to store a computer-readable instruction. When the computer-readable instruction is executed by the one or more processors, the one or more processors may be configured to transmit service registration information for electric power trading, and to transmit an electric power trading request. The electric power trading request may include electric power to sell, among eco-friendly electric power and general electric power, and a power capacity to sell, when a service registration confirmation is received in response to transmission of the service vehicle registration information, wherein electric power corresponding to the power capacity to sell is withdrawn from the vehicle according to the electric power trading request.

The vehicle may further include a high-voltage battery configured to store eco-friendly electric power and general electric power, and a battery management system (BMS) information storage unit configured to store BMS information of the high-voltage battery. The BMS information may further include a total power capacity (TPC), a remaining power capacity (RPC) of the eco-friendly electric power, and a remaining power capacity (RPC) of the general electric power in addition to information including a temperature and a state of charge (SOC) of the high-voltage battery.

The service registration information may include cooling performance information on the high-voltage battery. A withdrawal speed of withdrawn power may be limited based on the cooling performance information and a temperature of the high-voltage battery.

The one or more processors may be configured to update the BMS information.

The one or more processors may be configured to receive a request for the BMS information, to transmit the BMS information in response to the received request for the BMS information, and to receive sellable power capacity information. The sellable power capacity information may include a power capacity of the eco-friendly electric power and a power capacity of the general electric power when the SOC is greater than or equal to a preset SOC, after the BMS information is transmitted.

The one or more processors may be configured to receive the updated BMS information.

The one or more processors may be configured to request unit price information for each unit of electric power. The unit price information for each unit of electric power may include a unit price of each of the eco-friendly electric power and the general electric power. The one or more processors may be configured to receive the unit price information for each unit of electric power, after the unit price information for each unit of electric power is requested.

The one or more processors may be configured to subtract, according to a predetermined priority between the eco-friendly electric power and the general electric power, a power capacity (e.g., required) to drive a motor or a power capacity (e.g., required) to drive an electrical load from a RPC of corresponding electric power, when the motor or the electrical load is driven.

The eco-friendly electric power may be electric power, generated and stored by a renewable energy source. The general electric power may be electric power, generated and stored using a fossil fuel.

The general electric power may be electric power, charged by one of rapid charging, slow charging, or overnight charging.

The renewable energy source may be at least one of solar power and regenerative braking.

The vehicle may be a vehicle including a solar panel for generating electric power by solar power.

The service registration information may include at least one of service registration information including a service registrant and a code of the service registrant, vehicle information including a manufacturer and a year of the vehicle, and cooling performance information including cooling performance of the high-voltage battery.

The one or more processors may be configured to request a trading price, and to receive the trading price, after the trading price is requested. When the electric power to sell is eco-friendly electric power, the trading price may be a value obtained by subtracting a service fee from a value obtained by multiplying a power purchase agreement (PPA) unit price by the power capacity to sell, and the PPA unit price may be greater than a renewable energy certificate (REC) unit price. When the electric power to sell is general electric power, the trading price may be a value obtained by subtracting a service fee from a value obtained by multiplying a preset unit price by the power capacity to sell.

According to another aspect of the present disclosure, there is provided a service platform for electric power trading. The service platform may include one or more processors, and a storage medium configured to store a computer-readable instruction. When the computer-readable instruction is executed by one or more processors, the one or more processors may be configured to receive service registration information, to transmit a service registration confirmation in response to the received service registration information, to receive an electric power trading request, the electric trading request including electric power to sell, among eco-friendly electric power and general electric power, and a power capacity to sell, after the service registration confirmation is transmitted, and to withdraw electric power corresponding to the power capacity to sell from a vehicle according to the electric power trading request.

The service platform may further include an energy storage system (ESS) configured to store electric power withdrawn from a high-voltage battery included in the vehicle, and a state information storage unit configured to store state information of the ESS. The state information may include a TPC, a RPC of the eco-friendly electric power, and a RPC of the general electric power in addition to information including a temperature and an SOC of the ESS.

The service registration information may include cooling performance information on the high-voltage battery. The one or more processors may be configured to limit a withdrawal speed of electric power withdrawn from the high-voltage battery, based on the cooling performance information and a temperature of the high-voltage battery.

The one or more processors may be configured to request BMS information of the high-voltage battery, to receive the BMS information, after the BMS information is requested, and to transmit sellable power capacity information, the sellable power capacity information including a power capacity of the eco-friendly electric power and a power capacity of the general electric power when the SOC is greater than or equal to a preset SOC, based on the received BMS information.

The one or more processors may be configured to update the BMS information of the high-voltage battery, and to transmit the updated BMS information to the vehicle.

The one or more processors may be configured to receive a request for unit price information for each unit of electric power, the unit price information for each unit of electric power including a unit price of each of the eco-friendly electric power and the general electric power, and to transmit the unit price information for each unit of electric power in response to the request.

According to an example embodiment of the present disclosure, eco-friendly electric power and general electric power may be separately stored, and the eco-friendly electric power and the general electric power may be separately traded according to an electric power trading request, thereby inducing voluntary participation in the RE100 campaign.

### BRIEF DESCRIPTION OF DRAWINGS

The above and other aspects, features, and advantages of the present disclosure may be more understood from the following detailed description, taken in conjunction with the accompanying drawings.

FIG. 1 is a diagram illustrating an entire system including a vehicle and a service platform for electric power trading according to an example embodiment of the present disclosure.

FIG. 2A is a diagram illustrating battery management system (BMS) information of a high-voltage battery included in a vehicle according to an example embodiment of the present disclosure.

FIG. 2B is a diagram illustrating state information of an energy storage system (ESS) included in a service platform according to an example embodiment of the present disclosure.

FIG. 3 is a flowchart illustrating a power trading method between a vehicle and a service platform according to an example embodiment of the present disclosure.

FIG. 4 is a flowchart illustrating a power trading method between a vehicle and a service platform according to an example embodiment of the present disclosure.

FIG. 5 is a block diagram illustrating a computing device capable of fully or partially implementing a control unit of a vehicle and a control unit of a service platform according to an example embodiment of the present disclosure.

### DETAILED DESCRIPTION

Hereinafter, specific example embodiments of the present disclosure may be described with reference to the accompanying drawings. The following detailed description is provided to aid in a comprehensive understanding of a method, an apparatus, and/or a system described in the present specification. However, the detailed description is for illustrative purposes, and the present disclosure is not limited thereto.

In describing the example embodiments of the present disclosure, when it is determined that a detailed description of a technology related to the present disclosure may obscure the gist of the present disclosure, the detailed description thereof may be omitted. In addition, terms to be described below are terms defined in consideration of functions in the present disclosure, which may vary depending on intention or custom of a user or operator. Therefore, the meaning of these terms may be made based on the contents throughout the present specification. The terminology used herein is for the purpose of describing particular example embodiments and is not to be limiting of the example embodiments. As used herein, the singular forms “a,” “an,” and “the” are intended to include the plural forms as well, unless the context indicates otherwise. As used herein, the term “and/or” includes any one and any combination of any two or more of the associated listed items. It may be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

In the present disclosure, a vehicle may be an eco-friendly vehicle including a high-voltage battery and a motor, and may include, for example, a pure electric vehicle, a hybrid vehicle, a plug-in hybrid vehicle, and the like. The eco-friendly vehicle may be a vehicle including a solar panel. Further, the vehicle may be capable of generating eco-friendly electric power using solar power, and the vehicle may also be a vehicle capable of generating eco-friendly electric power using regenerative braking.

In addition, in the present disclosure, a service platform may refer to a facility including an energy storage facility. The facility may be capable of purchasing eco-friendly electric power or general electric power and then storing the eco-friendly electric power or the general electric power in the energy storage facility. The facility may be owned by an electric power operator capable of separately selling the eco-friendly electric power and the general electric power stored in the energy storage facility.

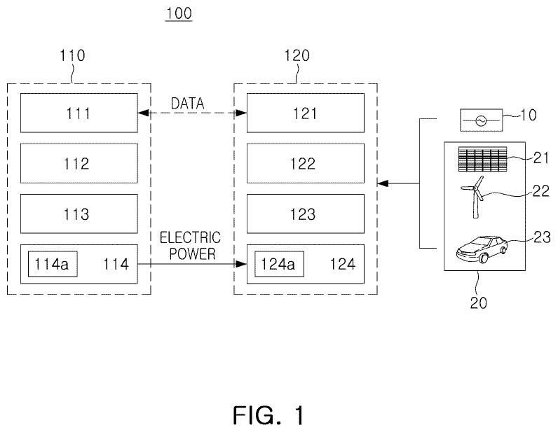

FIG. 1 is a diagram illustrating an (e.g., entire) system 100 including a vehicle and a service platform for electric power trading according to an example embodiment of the present disclosure.

As illustrated in FIG. 1, a vehicle 110 may include a communication unit 111, a control unit 112, a storage unit 113, and a high-voltage battery 114.

The communication unit 111 may transmit and receive various pieces of data to and from a service platform 120 under the control of the control unit 112.

The control unit 112 may transmit service registration information for electric power trading to the service platform 120. When a service registration confirmation is received from the service platform 120, the control unit 112 may transmit an electric power trading request to the service platform 120. Thereafter, electric power corresponding to a power capacity to sell may be withdrawn from the high-voltage battery 114 in response to the electric power trading request.

Here, the service registration information may include at least one of service registration information including a service registrant and a code of the service registrant, vehicle information including a manufacturer and a year of the vehicle, and cooling performance information including cooling performance of the high-voltage battery. Here, the cooling performance information may be cooling performance such as a cooling system or an air conditioning system for cooling the high-voltage battery 114.

The electric power trading request may include electric power to sell, among eco-friendly electric power and general electric power, and a power capacity to sell.

Here, the eco-friendly electric power may refer to power, generated and stored by a renewable energy source of the vehicle 110. The renewable energy source of the vehicle 110 may include, for example, solar power or regenerative braking. To this end, the vehicle 110 may include a solar panel, and may include a motor to enable regenerative braking.

The general electric power may refer to power, generated and stored using a fossil fuel, and may be electric power charged by one of rapid charging, slow charging, and overnight charging by electric power supplied from a charger.

In addition, when a request for battery management system (BMS) information is received from the service platform 120, the control unit 112 may transmit the BMS information to the service platform 120. Thereafter, sellable energy capacity information may be received from the service platform 120. Here, the sellable energy capacity information may include an energy capacity (unit: kWh) of each of the eco-friendly electric power and the general electric power when a state of charge (SOC) of the high-voltage battery 114 is greater than or equal to a preset SOC (for example, 10%).

In addition, the control unit 112 may request unit price information for each unit of electric power (unit: KRW/kWh) from the service platform 120, and may receive the unit price information for each unit of electric power from the service platform 120. Here, the unit price information for each unit of electric power may include a unit price of each of the eco-friendly electric power and the general electric power.

In addition, the control unit 112 may receive a trading price from the service platform 120. Here, the trading price may vary depending on a type of electric power.

For example, when the electric power to sell is eco-friendly electric power, the trading price may be a value obtained by subtracting a service fee from a value obtained by multiplying a power purchase agreement (PPA) unit price by an energy capacity to sell, and the PPA unit price may be greater than a renewable energy certificate (REC) unit price. Here, the PPA unit price may refer to a unit price when purchasing (e.g., directly) from a renewable energy business operator, and the REC unit price may refer to a renewable energy supply certificate price.

For example, when the electric power to sell is general electric power, the trading price may be a value obtained by subtracting a service fee from a value obtained by multiplying a preset unit price by a power capacity to sell. Here, the preset unit price may be a unit price set by an authorized institution determining a unit price of electric power, such as the KEPCO industry.

The storage unit 113 may store various pieces of data such as a program or service authentication information for implementing various operations of the control unit 112 described above. Although the service authentication information is described as being stored in the storage unit 113, the service authentication information may be stored in an additional database.

The high-voltage battery 114 may store eco-friendly electric power and general electric power. A voltage stored in the high-voltage battery 114 may be a high voltage of about 400V to 800V, but a specific voltage level may be modified depending on an example embodiment.

The high-voltage battery 114 may include a BMS information storage unit 114a for storing BMS information. Here, the BMS information may further include a total power capacity (TPC), a remaining power capacity (RPC) of the eco-friendly electric power, and a RPC of the general electric power in addition to information including a temperature and an SOC of the high-voltage battery.

The above-described BMS information may be updated by the control unit 112 of the vehicle 110 or updated by the service platform 120 to be described below, and may be provided to the vehicle 110.

That is, the control unit 112 may verify a type of electric power (e.g., eco-friendly electric power or general electric power) being charged while a charging operation is performed, and may store, in the BMS information storage unit 114a, information on the type and power capacity of electric power being charged. For example, when the electric power being charged is eco-friendly electric power, the electric power may be labeled as “1,” and when the electric power being charged is general electric power, the electric power may be labeled as “0,”thereby verifying the electric power being charged.

Similarly, the control unit 112 may verify a type of electric power (e.g., eco-friendly electric power or general electric power) being discharged while a discharging operation is performed, and may store, in the BMS information storage unit 114a, information on the type and power capacity of electric power being discharged. For example, when the electric power being discharged is eco-friendly electric power, the electric power may be labeled as “1,” and when the electric power being discharged is general electric power, the electric power may be labeled as “0,” thereby verifying the electric power being discharged.

According to an example embodiment of the present disclosure, when the high-voltage battery 114 is discharged due to driving of a motor or driving of an electrical load, the control unit 112 may subtract, according to a predetermined priority between the eco-friendly electric power and the general electric power, a power capacity (e.g., required) to drive the motor or a power capacity (e.g., required) to drive the electrical load from a RPC of corresponding electric power.

For example, when a priority of discharging is set in the order of general electric power to eco-friendly electric power, a power capacity corresponding to the general electric power, may first be deducted when a discharging operation is performed. Thereafter, when the power capacity corresponding to the general electric power is fully consumed, a power capacity corresponding to the eco-friendly electric power may be deducted. Such a configuration is an example embodiment of the present disclosure. A ratio between the general electric power and the eco-friendly electric power may be set, and a power capacity may be deducted according to the ratio.

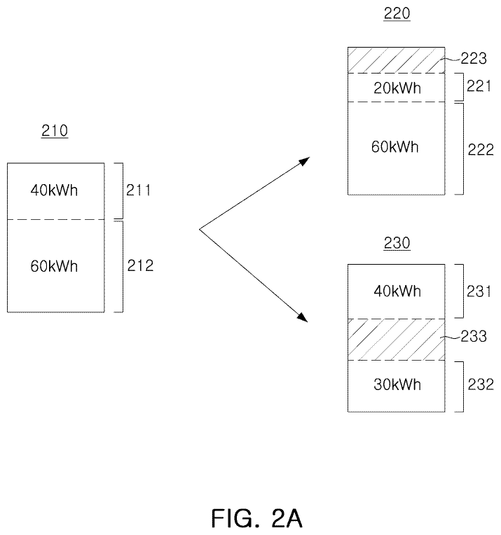

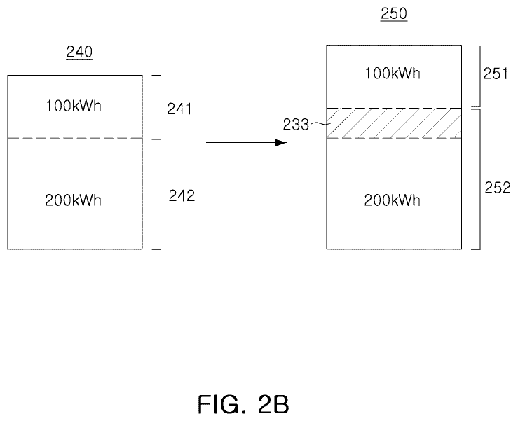

FIG. 2A is a diagram illustrating BMS information of a high-voltage battery included in a vehicle according to an example embodiment of the present disclosure. Reference numeral 210 denotes a current energy capacity of the high-voltage battery 114, reference numeral 220 denotes a RPC of the high-voltage battery 114 when a motor or an electrical load is driven in a case in which priority is set in the order of general electric power to eco-friendly electric power, and reference numeral 230 denotes a RPC of the high-voltage battery 114 in a case in which electric power to sell is set as eco-friendly electric power when electric power trading is requested.

As illustrated in reference numeral 210 of FIG. 2A, a current power capacity of the high-voltage battery 114 may be 40 kWh for general electric power 211 and 60 kWh for eco-friendly electric power 212.

As illustrated in reference numeral 220 of FIG. 2A, when 20 kWh of electric power 223 is consumed when the motor or the electrical load is driven, the general electric power may first be deducted. Accordingly, a RPC after the motor or the electrical load is driven may be 20 kWh for the general electric power 221 and 60 kWh for the eco-friendly electric power 222.

As illustrated in reference numeral 230 of FIG. 2A, when electric power to sell is set as eco-friendly electric power in an electric power trading request, the eco-friendly electric power may be deducted. Accordingly, when 30 kWh of electric power 233 is sold, a RPC may be 40 kWh for the general electric power 231 and 30 kWh for the eco-friendly electric power 232.

The service platform 120 may include a communication unit 121, a control unit 122, a storage unit 123, and an energy storage system (ESS) 124.

The communication unit 121 may transmit and receive various pieces of data to and from the vehicle 110 under the control of the control unit 122.

The control unit 122 may receive service registration information from the vehicle 110, and may transmit a service registration confirmation to the vehicle 110 in response to the received service registration information. The service registration confirmation may be transmitted when service registration information stored in a storage unit 123 to be described below corresponds to the service registration information received from the vehicle 110.

Thereafter, when the electric power trading request is received from the vehicle 110, the control unit 122 may withdraw electric power corresponding to a power capacity to sell included in the electric power trading request, from the high-voltage battery 114 included in the vehicle 110, and may store the electric power in the ESS 124.

The above-described service registration information may include at least one of pieces of cooling performance information including cooling performance of the high-voltage battery, and the control unit 122 may limit a withdrawal speed of electric power withdrawn from the high-voltage battery 114, based on the cooling performance information and a temperature of the high-voltage battery 114.

The control unit 122 may request BMS information of the high-voltage battery 114 from the vehicle 110. When the BMS information is received from the vehicle 110, the control unit 122 may transmit sellable power capacity information based on the BMS information. Here, the sellable power capacity may include a power capacity of the eco-friendly electric power and a power capacity of each of the general electric power when an SOC of the high-voltage battery 114 is greater than or equal to a preset SOC (for example, 10%).

In addition, the control unit 122 may update the BMS information of the high-voltage battery 114, transmit the updated BMS information to the vehicle 110, and update state information of the ESS 124.

In addition, the control unit 122 may transmit unit price information for each unit of electric power to the vehicle 110. The unit price information for each unit of electric power may include a unit price of each of eco-friendly electric power and general electric power, as described above.

In addition, the control unit 122 may provide (e.g., pay) a trading price to a user of the vehicle 110.

Here, the electric power to sell is eco-friendly electric power, the trading price may be a value obtained by subtracting a service fee from a value obtained by multiplying a PPA unit price by a power capacity to sell, and the PPA unit price may be greater than an REC unit price. In addition, when the electric power to sell is general electric power, the trading price may be a value obtained by subtracting a service fee from a value obtained by multiplying a preset unit price by a power capacity to sell, and a unit price of overnight electricity may be less than a unit price of industrial electricity.

The storage unit 123 may store various pieces of data such as a program or service authentication information for implementing various operations of the control unit 122 described above. Although the service authentication information is described as being stored in the storage unit 123, the service authentication information may be stored in an additional database.

The ESS 124, a device for storing electric power withdrawn from the high-voltage battery 114 of the vehicle 110, may be, for example, a device for storing electric power using various batteries (e.g., battery technologies) such as a lithium-ion battery, a lead-acid battery, and the like.

The ESS 124 may include a state information storage unit 124a for storing state information of the ESS. Here, the state information of the ESS may include a TPC, a RPC of the eco-friendly electric power, and a RPC of the general electric power in addition to information including a temperature and an SOC of the ESS.

FIG. 2B is a diagram illustrating state information of an ESS included in a service platform according to an example embodiment of the present disclosure.

Reference numeral 240 denotes a current energy capacity of the ESS 124, and reference numeral 250 denotes an energy capacity after an electric power withdrawn from the high-voltage battery 114 of the vehicle 110 is stored in the ESS 124 according to an electric power trading request.

As illustrated in reference numeral 240 of FIG. 2B, a current power capacity of the ESS 124 may be 100 kWh for general electric power 241 and 200 kWh for eco-friendly electric power 242.

As illustrated in reference numeral 250 of FIG. 2B, when 30 kWh of power 233 is withdrawn and stored from the high-voltage battery 114 of the vehicle 110 according to an electric power trading request, a RPC may be 100 kWh for general electric power 251 and 230 kWh for eco-friendly electric power 252.

Referring back to FIG. 1, the ESS 124 may store various types of electric power.

For example, the ESS 124 may receive and store general electric power from a charger 10. The general electric power, electric power generated and stored using a fossil fuel, may be electric power charged by one of rapid charging, slow charging, and overnight charging.

In addition, the ESS 124 may receive and store eco-friendly electric power from an eco-friendly facility 20 such as a solar panel 21, a wind power facility 22, or an eco-friendly vehicle 23. The solar panel 21 may provide solar power, the wind power facility 22 may provide wind power, and the eco-friendly vehicle 23 may provide eco-friendly electric power, generated by using regenerative braking using a motor or solar power using a solar panel as a renewable energy source, to the ESS 124.

As described above, according to an example embodiment of the present disclosure, eco-friendly electric power and general electric power may be separately stored, and the eco-friendly electric power and the general electric power are separately traded according to an electric power trading request, thereby providing economic benefits to a vehicle and a service platform operator and inducing participation in the RE100 campaign.

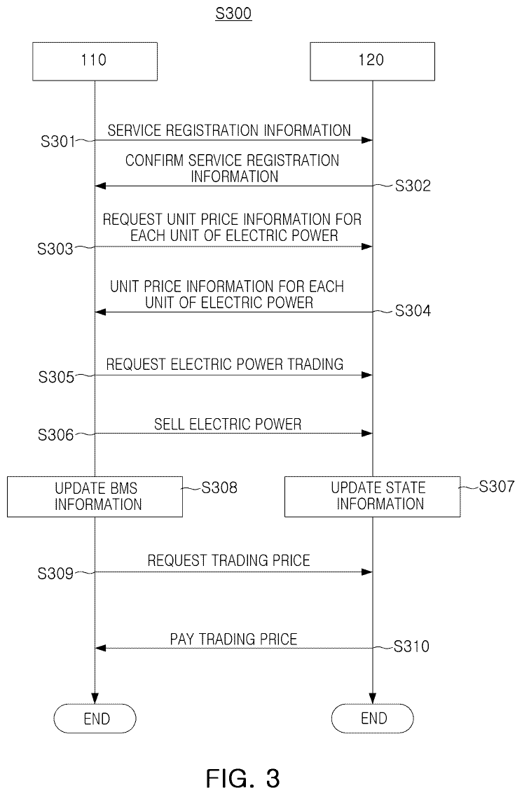

FIG. 3 is a flowchart illustrating a power trading method between a vehicle and a service platform according to an example embodiment of the present disclosure.

Hereinafter, an electric power trading method between a vehicle and a service platform according to an example embodiment of the present disclosure may be described with reference to FIG. 3. However, for simplicity of the present disclosure, descriptions overlapping those of FIGS. 1 to 2B may be omitted.

Referring to FIG. 3, an electric power trading method (S300) between a vehicle and a service platform according to an example embodiment of the present disclosure may be started by an operation of transmitting service registration information for electric power trading from a vehicle 110 to a service platform 120 (S301).

The service registration information may include at least one of service registration information including a service registrant and a code of the service registrant, vehicle information including a manufacturer and a year of the vehicle, and cooling performance information including cooling performance of a high-voltage battery. Here, the cooling performance information may be a cooling performance such as a cooling system or an air conditioning system for cooling the high-voltage battery, as described above.

The service platform 120 may determine whether the received service registration information corresponds to pre-stored service registration information, and may transmit a service registration confirmation to the vehicle 110 when the received service registration information corresponds to the pre-stored service registration information (S302).

Thereafter, the vehicle 110 may request unit price information for each unit of electric power from the service platform 120 (S303), and the service platform 120 may transmit unit price information for each unit of electric power (unit: KRW/kWh) to the vehicle 110 (S304). Here, the unit price information for each unit of electric power may include a unit price of each of eco-friendly electric power and general electric power, as described above.

Thereafter, the vehicle 110 may transmit an electric power trading request to the service platform 120 (S305). The electric power trading request may include electric power to sell, among the eco-friendly electric power and the general electric power, and a power capacity to sell, as described above.

Thereafter, electric power may be sold from the vehicle 110 to the service platform 120 (S306). Specifically, the service platform 120 may withdraw electric power corresponding to the energy power to sell from the vehicle 110.

Thereafter, the service platform 120 may update state information of an ESS (S307).

Here, the state information of the ESS may include a TPC, a RPC of the eco-friendly electric power, and a RPC of the general electric power in addition to information including a temperature and an SOC of the ESS, as described above.

Similarly, the vehicle 110 may update BMS information (S308).

Here, BMS information further includes the total power capacity (TPC), the remaining power capacity (RPC) of the eco-friendly electric power, and the remaining power capacity (RPC) of the general electric power in addition to the information including the temperature and state of charge (SOC) of the high-voltage battery 114, as described above.

Finally, the vehicle 110 may request a trading price from the service platform 120 (S309), and the vehicle 110 may receive the trading price (S310).

Here, the trading price may vary depending on a type of electric power, as described above.

For example, when the electric power to sell is eco-friendly electric power, the trading price may be a value obtained by subtracting a service fee from a value obtained by multiplying a PPA unit price by an energy power to sell, and the PPA unit price may be greater than a REC unit price. Here, the PPA unit price may refer to a unit price when purchasing (e.g., directly) from a renewable energy business operator, and the REC unit price may refer to a renewable energy supply certificate price.

For example, when the electric power to sell is general electric power, the trading price may be a value obtained by subtracting a service fee from a value obtained by multiplying a preset unit price by a power capacity to sell. Here, the preset unit price may be a unit price set by an authorized institution determining a unit price of electric power, such as the KEPCO industry, as described above.

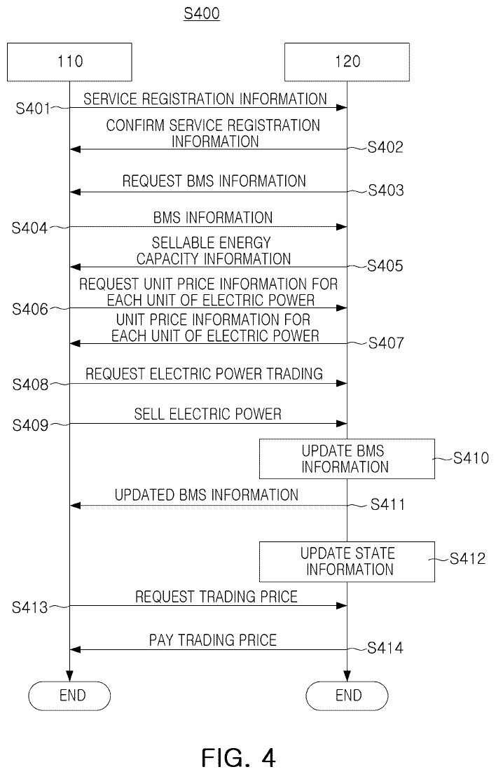

FIG. 4 is a flowchart illustrating a power trading method between a vehicle and a service platform according to an example embodiment of the present disclosure. FIG. 4 may differ from FIG. 3 in that operations S403 to S405, S410, and S411 are further included.

Referring to FIG. 4, an electric power trading method (S400) between a vehicle and a service platform according to an example embodiment of the present disclosure may be started by an operation of transmitting service registration information for electric power trading from a vehicle 110 to a service platform 120 (S401).

The service platform 120 may determine whether the received service registration information corresponds to pre-stored service registration information, and may transmit a service registration confirmation to the vehicle 110 when the received service registration information corresponds to the pre-stored service registration information (S402).

Thereafter, the service platform 120 may request BMS information from the vehicle 110 (S403), and the vehicle 110 may transmit the BMS information to the service platform 120 (S404).

Thereafter, the service platform 120 may transmit sellable power capacity information to the vehicle 110. Here, the sellable power capacity information may include a power capacity of each of eco-friendly electric power and general electric power when an SOC is greater than or equal to a preset SOC, as described above.

Thereafter, the vehicle 110 may request unit price information for each unit of electric power from the service platform 120 (S406), and the service platform 120 may transmit the unit price information for each unit of electric power (unit: KRW/kWh) to the vehicle 110 (S407).

Thereafter, the vehicle 110 may transmit an electric power trading request to the service platform 120 (S408).

Thereafter, electric power may be sold from the vehicle 110 to the service platform 120 (S409). Specifically, the service platform 120 may withdraw electric power corresponding to the power capacity to sell, from the vehicle 110.

Thereafter, the service platform 120 may update the BMS information (S410) and transmit the updated BMS information to the vehicle 110 (S411).

Thereafter, the service platform 120 may update state information of an ESS (S412).

Finally, the vehicle 110 may request a trading price from the service platform 120 (S413), and the vehicle 110 may receive the trading price (S414).

As described above, according to an example embodiment of the present disclosure, eco-friendly electric power and general electric power may be separately stored, and the eco-friendly electric power and the general electric power are separately traded according to an electric power trading request, thereby providing economic benefits to a vehicle and a service platform operator and inducing participation in the RE100 campaign.

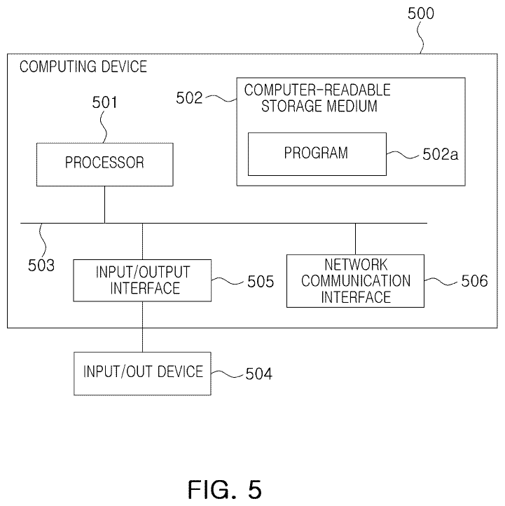

FIG. 5 is a block diagram of a computing device capable of fully or partially implementing a control unit 112 of a vehicle and a control unit 122 of a service platform according to an example embodiment of the present disclosure.

As illustrated in FIG. 5, the computing device 500 may include at least one processor 501, a computer-readable storage medium 502, and a communication bus 503.

The processor 501 may cause the computing device 500 to operate according to the example embodiments described above. For example, the processor 501 may execute one or more programs stored in the computer-readable storage medium 502. The one or more programs may include one or more computer-executable instructions. When executed by the processor 501, the one or more computer-executable instructions may be configured to cause the computing device 500 to perform operations according to example embodiments.

The computer-readable storage medium 502 may be configured to store the computer-executable instructions or program code, program data, and/or other suitable forms of information. A program 502a, stored in the computer-readable storage medium 502, may include a set of instructions executable by the processor 501. In an example embodiment, the computer-readable storage medium 502 may be a memory (e.g., a volatile memory such as a random access memory, a non-volatile memory, or any suitable combination thereof), one or more magnetic disk storage devices, optical disk storage devices, flash memory devices, other types of storage media that are accessible by the computing device 500 and are capable of storing (e.g., desired) information, or any suitable combinations thereof.

The communication bus 503 may interconnect various other components of the computing device 500, including the processor 501 and the computer-readable storage medium 502.

The computing device 500 may also include one or more input/output interfaces 505 providing an interface for one or more input/output devices 504, and one or more network communication interfaces 506. The input/output interface 505 and the network communication interface 506 may be connected to the communication bus 503. A network may be one of a cellular network, for example, a global system for mobile communications (GSM), an enhanced data rate for GSM evolution (EDGE), a general packet radio service (GPRS), a code division multiple access (CDMA), a time division-CDMA (TD-CDMA), a universal mobile telecommunications system (UMTS), or long-term evolution (LTE), or another cellular network.

The input/output device 504 may be connected to other components of the computing device 500 through the input/output interface 505. The example input/output device 504 may include a pointing device (e.g., a mouse or trackpad), a keyboard, a touch input device (e.g., a touchpad or touchscreen), a voice or sound input device, input devices such as various types of sensor devices and/or photographing devices, and/or output devices such as a display device, a printer, a speaker, and/or a network card. The example input/output device 504 may be included in the computing device 500 as a component included in the computing device 500, or may be connected to the computing device 500 as a device, distinct from the computing device 500.

Example embodiments of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the example embodiments, or may be of the well-known kind and available to those having skill in the computer software arts. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code that may be executed by the computer using an interpreter.

While example embodiments have been shown and described above, it may be apparent to those skilled in the art that modifications and variations could be made without departing from the scope of the present disclosure as defined by the claims.

What is claimed is:

1. A vehicle for electric power trading, the vehicle comprising:
one or more processors; and
a storage medium configured to store a computer-readable instruction,
wherein, when the computer-readable instruction is accessed and executed by the one or more processors, the one or more processors are configured to
transmit service registration information for electric power trading, and
transmit an electric power trading request, the electric power trading request including electric power to sell, among eco-friendly electric power and general electric power, and a power capacity to sell, when a service registration confirmation is received in response to transmission of the service registration information,
wherein electric power corresponding to the power capacity to sell is withdrawn from the vehicle according to the electric power trading request.

2. The vehicle of claim 1, further comprising:
a high-voltage battery configured to store eco-friendly electric power and general electric power; and
a battery management system (BMS) information storage unit configured to store BMS information of the high-voltage battery,
wherein the BMS information further includes a total power capacity (TPC), a remaining power capacity (RPC) of the eco-friendly electric power, and a remaining power capacity (RPC) of the general electric power in addition to information including a temperature and a state of charge (SOC) of the high-voltage battery.

3. The vehicle of claim 2, wherein
the service registration information includes cooling performance information on the high-voltage battery, and
a withdrawal speed of withdrawn power is limited based on the cooling performance information and a temperature of the high-voltage battery.

4. The vehicle of claim 2, wherein the one or more processors are configured to update the BMS information.

5. The vehicle of claim 2, wherein the one or more processors are configured to:
receive a request for the BMS information;
transmit the BMS information in response to the received request for the BMS information; and
receive sellable power capacity information, the sellable power capacity information including a power capacity of the eco-friendly electric power and a power capacity of the general electric power when the SOC is greater than or equal to a preset SOC, after the BMS information is transmitted.

6. The vehicle of claim 5, wherein the one or more processors are configured to receive updated BMS information.

7. The vehicle of claim 1, wherein the one or more processors are configured to:
request unit price information for each unit of electric power, the unit price information for each unit of electric power including a unit price of each of the eco-friendly electric power and the general electric power; and
receive the unit price information for each unit of electric power, after the unit price information for each unit of electric power is requested.

8. The vehicle of claim 1, wherein the one or more processors are configured to subtract, according to a predetermined priority between the eco-friendly electric power and the general electric power, a power capacity to drive a motor or a power capacity to drive an electrical load from a remaining power capacity of corresponding electric power, when the motor or the electrical load is driven.

9. The vehicle of claim 1, wherein
the eco-friendly electric power is electric power, generated and stored by a renewable energy source, and
the general electric power is electric power, generated and stored using a fossil fuel.

10. The vehicle of claim 9, wherein the general electric power is electric power, charged by one of rapid charging, slow charging, or overnight charging.

11. The vehicle of claim 10, wherein the renewable energy source is at least one of solar power and regenerative braking.

12. The vehicle of claim 1, wherein the vehicle is a vehicle including a solar panel for generating electric power by solar power.

13. The vehicle of claim 2, wherein the service registration information includes at least one of service registration information including a service registrant and a code of the service registrant, vehicle information including a manufacturer and a year of the vehicle, and cooling performance information including cooling performance of the high-voltage battery.

14. The vehicle of claim 1, wherein
the one or more processors are configured to:
request a trading price; and
receive the trading price, after the trading price is requested,
when the electric power to sell is eco-friendly electric power, the trading price is a value obtained by subtracting a service fee from a value obtained by multiplying a power purchase agreement (PPA) unit price by the power capacity to sell, and the PPA unit price is greater than a renewable energy certificate (REC) unit price, and
when the electric power to sell is general electric power, the trading price is a value obtained by subtracting a service fee from a value obtained by multiplying a preset unit price by the power capacity to sell.

15. A service platform for electric power trading, the service platform comprising:
one or more processors; and
a storage medium configured to store a computer-readable instruction,
wherein, when the computer-readable instruction is accessed and executed by one or more processors, the one or more processors are configured to
receive service registration information,
transmit a service registration confirmation in response to the received service registration information,
receive an electric power trading request, the electric power trading request including electric power to sell, among eco-friendly electric power and general electric power, and a power capacity to sell, after the service registration confirmation is transmitted, and
withdraw electric power corresponding to the power capacity to sell from a vehicle according to the electric power trading request.

16. The service platform of claim 15, further comprising:
an energy storage system (ESS) configured to store electric power withdrawn from a high-voltage battery included in the vehicle; and
a state information storage unit configured to store state information of the ESS,
wherein the state information includes a total power capacity (TPC), a remaining power capacity (RPC) of the eco-friendly electric power, and a remaining power capacity (RPC) of the general electric power in addition to information including a temperature and a state of charge (SOC) of the ESS.

17. The service platform of claim 16, wherein
the service registration information includes cooling performance information on the high-voltage battery, and
the one or more processors are configured to limit a withdrawal speed of electric power withdrawn from the high-voltage battery, based on the cooling performance information and a temperature of the high-voltage battery.

18. The service platform of claim 16, wherein the one or more processors are configured to:
request battery management system (BMS) information of the high-voltage battery;
receive the BMS information, after the BMS information is requested; and
transmit sellable power capacity information, the sellable power capacity information including a power capacity of the eco-friendly electric power and a power capacity of the general electric power when the SOC is greater than or equal to a preset SOC, based on the received BMS information.

19. The service platform of claim 18, wherein the one or more processors are configured to:
update the BMS information of the high-voltage battery; and
transmit the updated BMS information to the vehicle.

20. The service platform of claim 15, wherein the one or more processors are configured to:
receive a request for unit price information for each unit of electric power, the unit price information for each unit of electric power including a unit price of each of the eco-friendly electric power and the general electric power; and
transmit the unit price information for each unit of electric power in response to the request.
